(19) United States
(12) Patent Application Publication
(10) Pub. No.: US 2021/0240396 A1
(43) Pub. Date: Aug. 5, 2021

(54) STORAGE DEVICE

(71) Applicant: Panasonic Intellectual Property Management Co., Ltd., Osaka (JP)

(72) Inventors: Shinji INOUE, Osaka (JP); Takuji MAEDA, Osaka (JP)

(21) Appl. No.: 17/235,819

(22) Filed: Apr. 20, 2021

Related U.S. Application Data
(63) Continuation of application No. PCT/JP2019/038973, filed on Oct. 2, 2019.

(30) Foreign Application Priority Data
Nov. 9, 2018 (JP) 2018-210987

(51) Int. Cl. G06F 3/06; G06F 12/1009; G06F 12/0806; G06F 21/44

(52) U.S. Cl. CPC G06F 3/0659; G06F 3/0604; G06F 3/0622; G06F 2212/657; G06F 12/1009; G06F 12/0806; G06F 21/445; G06F 3/0679

(57) ABSTRACT

A storage device is connected to a host device. The storage device includes a non-volatile memory, a logical area manager that divides the non-volatile memory into a plurality of logical areas, an area information storage that stores information regarding the plurality of logical areas, an access pattern manager that manages access patterns that are designated by the host device and each correspond to a corresponding one of the plurality of logical areas, an access pattern storage that stores information regarding the access patterns, an access pattern processing manager that selects, when any one of the plurality of logical areas is accessed from the host device, an access pattern corresponding to the any one of the plurality of logical areas accessed from the information, and an access processing management and execution unit that performs processing on the non-volatile memory based on the access pattern and transfers data to the host device.

### 1. TECHNICAL FIELD

The present disclosure relates to a storage device that transfers data between a host device and a memory device.

### 2. DESCRIPTION OF THE RELATED ART

As a high-speed serial interface, PCI Express (registered trademark, hereinafter referred to as PCIe) is used in various electronic devices such as personal computers. For example, the high-speed serial interface is being considered for use in an in-vehicle system, and integration with an electric controller unit (hereinafter referred to as an ECU) incorporated in a vehicle is also being considered.

For example, in the in-vehicle field, when a plurality of ECUs is integrated, it is also necessary to integrate storages connected to individual ECUs. As the storage in the in-vehicle field, the mainstream is not what is called a PC server but a storage using a solid state drive (SSD) or an SD card. For example, technologies for SD cards and SD card-enabled hosts are disclosed in US 2015/0331479 A.

Patent Literature (PTL) 1: US 2015/0331479 A

### SUMMARY

The present disclosure provides a storage device that constitutes one virtual storage with which a plurality of ECUs is optimized for individual ECUs.

The storage device in the present disclosure is a storage device that is connected to a host device, the storage device including a non-volatile memory that stores data, a logical area manager that divides the non-volatile memory into a plurality of logical areas to manage the plurality of logical areas, an area information storage that stores information regarding the plurality of logical areas managed by the logical area manager, an access pattern manager that manages access patterns that are designated by the host device and each correspond to a corresponding one of the plurality of logical areas that has been divided, an access pattern storage that stores information regarding the access patterns managed by the access pattern manager, an access pattern processing manager that selects, when any one of the plurality of logical areas is accessed from the host device, an access pattern corresponding to the any one of the plurality of logical areas accessed from the information regarding the access patterns stored in the access pattern storage, and an access processing management and execution unit that performs processing on the non-volatile memory based on the access pattern designated by the access pattern processing manager and transfers data to the host device.

The storage device in the present disclosure can be provided as one storage with which a plurality of ECUs is optimized for individual ECUs. In addition, when the plurality of ECUs is integrated, by assuming each application as an individual host device, it is possible to cover a storage function optimum for applications with different required areas and performances by one storage.

### BRIEF DESCRIPTION OF DRAWINGS

FIG. 1 is a configuration diagram of a storage device according to a first exemplary embodiment.

FIG. 2 is a flowchart of setting area information in the storage device according to the first exemplary embodiment.

FIG. 3 is a diagram illustrating an example of a logically divided non-volatile memory and an example of logical area management information in the storage device according to the first exemplary embodiment.

FIG. 4 is a flowchart of setting access information in the storage device according to the first exemplary embodiment.

FIG. 5 is a diagram illustrating an example of access pattern information in the storage device according to the first exemplary embodiment.

FIG. 6 is a diagram illustrating an example of information managed by a host in the storage device according to the first exemplary embodiment.

FIG. 7 is a flowchart of basic processing in the storage device according to the first exemplary embodiment.

FIG. 8 is a flowchart of executing pattern processing in the storage device according to the first exemplary embodiment.

FIG. 9 is a configuration diagram of a storage device according to a second exemplary embodiment.

FIG. 10 is a flowchart of setting area information in the storage device according to the second exemplary embodiment.

FIG. 11 is a flowchart of an authentication process in the storage device according to the second exemplary embodiment.

FIG. 12 is a flowchart of setting access information in the storage device according to the second exemplary embodiment.

FIG. 13 is a diagram illustrating an example of access pattern information in the storage device according to the second exemplary embodiment.

FIG. 14 is a diagram illustrating an example of host information stored in a host information storage in the storage device according to the second exemplary embodiment.

FIG. 15 is a diagram illustrating an example of host unique information stored in a host unique information storage of host device 22 in the storage device according to the second exemplary embodiment.

FIG. 16 is a diagram illustrating an example of host unique information stored in a host unique information storage of host device 44 in the storage device according to the second exemplary embodiment.

FIG. 17 is a flowchart of basic processing in the storage device according to the second exemplary embodiment.

FIG. 18 is a flowchart of executing pattern processing in the storage device according to the second exemplary embodiment.

### DETAILED DESCRIPTION

Hereinafter, exemplary embodiments will be described in detail with appropriate reference to the drawings. However, descriptions in more detail than necessary may be omitted. For example, the detailed description of already well-known matters and the overlap description of substantially same configurations may be omitted. This is to avoid unnecessarily redundancy in the following description, and to facilitate understanding by those skilled in the art.

Note that the inventors provide the accompanying drawings and the following description in order for those skilled in the art to fully understand the present disclosure, and are not intended to limit the subject matter described in the claims by them.

### 1. Background of Devising Exemplary Embodiment

In a system that uses a storage, a host interface provided in a host and a storage interface held by the storage connect the host and the storage. Regarding access performance and functions with respect to the storage, the host reads information of the storage and performs control corresponding to the storage or performs control regardless of characteristics of the storage, and storing data in the storage and reading data from the storage are performed with the storage being irrelevant to a request of the host. Further, the storage performs control suitable for a non-volatile memory used. Consequently, there is one processing pattern for the entire storage, and even if the area is divided, the processing pattern of individual areas become identical. Further, it is possible to constitute a storage having a plurality of processing pattern characteristics by configuring individual areas with different non-volatile memories, but when focusing on the individual fixed areas, there is one processing pattern.

Thus, in the storage that performs only processing suitable for the non-volatile memory that constitutes the storage, the position and size of an area to be used are determined in advance, and thus the host device can achieve functions by individually preparing and using a storage having a configuration and performance that satisfies requirements, or by using the configuration and performance of the connected storage as they are.

Incidentally, for example, in the in-vehicle field, integration of a plurality of ECUs is needed, and storages connected to the plurality of ECUs are also needed to be integrated at the same time.

Accordingly, the present disclosure solves the above-described problem, and is a storage device that is connected to the host device, the storage device including a non-volatile memory that stores data, a logical area manager that divides the non-volatile memory into a plurality of logical areas to manage the plurality of logical areas, an area information storage that stores information regarding the logical areas managed by the logical area manager, an access pattern manager that manages access patterns that are designated by the host device and each correspond to a corresponding one of the plurality of logical areas that has been divided, an access pattern storage that stores access pattern information managed by the access pattern manager, an access pattern processing manager that selects, when any one of the plurality of logical areas is accessed from the host device, an access pattern corresponding to the any one of the plurality of logical areas accessed from the access pattern information stored in the access pattern storage, and an access processing management and execution unit that performs processing on the non-volatile memory based on the access pattern selected by the access pattern processing manager and transfers data to the host device. Thus, with physically one storage, it is possible to achieve characteristics of a plurality of storages and provide storage functions needed by a plurality of ECUs.

### 2. First Exemplary Embodiment

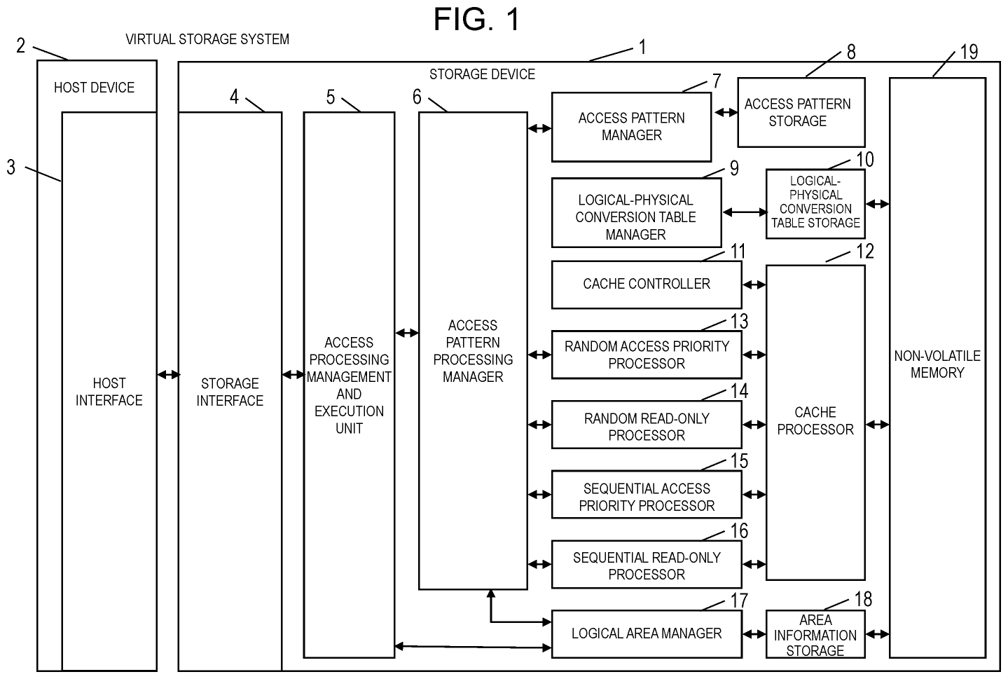

Hereinafter, a first exemplary embodiment will be described with reference to FIGS. 1 to 8.

### 2.1. Configuration of Virtual Storage System

FIG. 1 is a configuration diagram of a virtual storage system according to the first exemplary embodiment. The virtual storage system is constituted of host device 2 and storage device 1.

Storage device 1 is a virtual storage connected to host device 2 having host interface 3 via storage interface 4. Storage device 1 has logical-physical conversion table manager 9 that manages a logical-physical conversion table for converting a physical address of non-volatile memory 19 and a logical address to be accessed from host device 2, logical-physical conversion table storage 10 that stores the logical-physical conversion table managed by logical-physical conversion table manager 9, logical area manager 17 that divides non-volatile memory 19 storing data into several logical areas in response to a request from host device 2 to manage non-volatile memory 19, area information storage 18 that stores information regarding the logical areas managed by logical area manager 17, random access priority processor 13 that preferentially processes random access according to an access pattern requested by host device 2, random read-only processor 14 that performs random but read-only processing, sequential access priority processor 15 that preferentially processes sequential access for accessing data such as image data and video data, sequential read-only processor 16 that performs sequential but read-only processing, access pattern manager 7 that manages an access pattern for the individual divided areas specified by host device 2, access pattern storage 8 that stores access pattern information managed by access pattern manager 7, cache controller 11 that manages cache processing, cache processor 12 that is cache-controlled, access pattern processing manager 6 that automatically selects optimum processing based on the access pattern information stored in access pattern storage 8 when there is access from host device 2, and access processing management and execution unit 5 that performs optimum processing based on an instruction from access pattern processing manager 6 and transfers data to host device 2 via storage interface 4. Thus, when host device 2 accesses a divided area of non-volatile memory 19, optimum processing is performed and data read from non-volatile memory 19 is transferred to host device 2.

Note that storage device 1 is, for example, an information recording medium such as an SD card, and host device 2 is hardware (ECU, central processing unit (hereinafter referred to as CPU), or the like) that instructs writing on or reading from the information recording medium such as an SD card. Note that host device 2 may also be an operating system (hereinafter referred to as an OS) or an application that operates on the hardware. Note that host device 2 may also be a process or a thread operating on the hardware.

### 2.2. Operation of Virtual Storage System

Operations of the virtual storage system according to the first exemplary embodiment will be described by dividing them into a phase in which area information and access pattern processing information are set in advance, and a phase in which the virtual storage system operates based on the set information.

### 2.2.1 Operation in Information Setting Phase

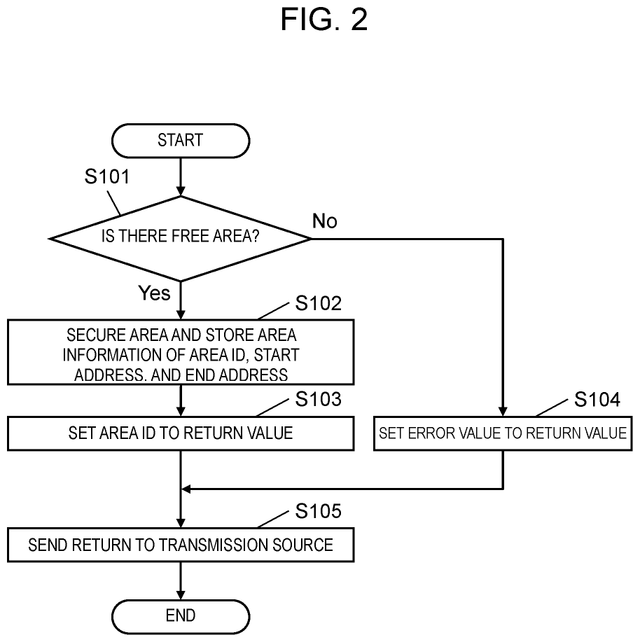

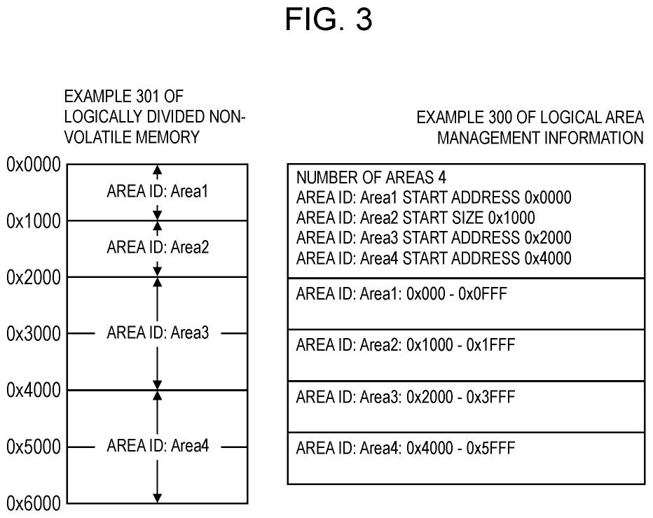

FIG. 2 is a flowchart illustrating an operation of the phase in which the area information is set in storage device 1 according to the first exemplary embodiment. FIG. 3 is a diagram illustrating an example of setting information created in a setting flow of the area information illustrated in FIG. 2.

First, host device 2 sends a command for dividing the area of non-volatile memory 19 to storage device 1 connected by host interface 3 and storage interface 4. The command is interpreted by access processing management and execution unit 5, and logical area manager 17 performs division and management so as not to have any duplication. Information regarding a logical area generated by logical area manager 17 is stored in area information storage 18.

Specifically, when host device 2 sends area information needed as a first area, logical area manager 17 checks whether or not there is a free area for a specified size (step S101), and when there is no free area, an error value is set to a return value (step S104), which is returned to host device 2 (step S105). On the other hand, when there is a free area, the area is secured and area information including an area ID, a start address, and a final address is stored in area information storage 18 (step S102). The area ID, for example, “Area1” (see FIG. 3) is set as a return value (step S103), the return value is returned to the transmission source (step S105), and the process ends. Example 300 of logical area management information (example of information regarding logical areas) illustrated in FIG. 3 is stored in area information storage 18. The non-volatile memory is divided as in example 301 of the logically divided non-volatile memory illustrated in FIG. 3.

Subsequently, host device 2 sends information regarding use of the divided area described above to storage device 1.

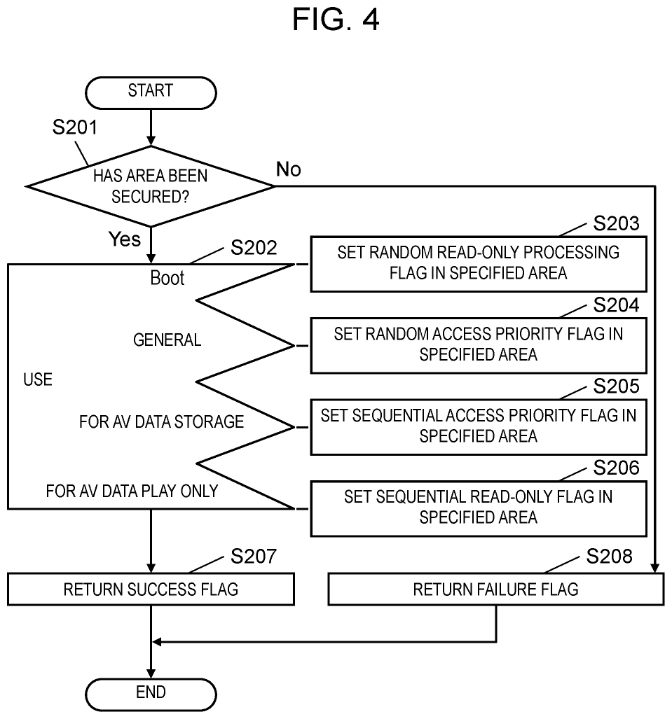

FIG. 4 illustrates a flow of processing performed by storage device 1 that has received information regarding use of the divided area from host device 2.

First, it is checked whether or not a specified area has already been secured (step S201), and when it has not been secured, a failure flag is returned to the transmission source (step S208) and the process ends. On the other hand, when the area has been secured, if the use is for boot, for example, according to a specified use (step S202), a random read-only processing flag is set in the specified area as access pattern information (step S203). As other uses, generally, there are uses for AV data storage and for AV data play only. A flag of access pattern processing according to each use is set in the specified area (steps S204 to S206), a success flag is returned to the transmission source (step S207), and the process ends.

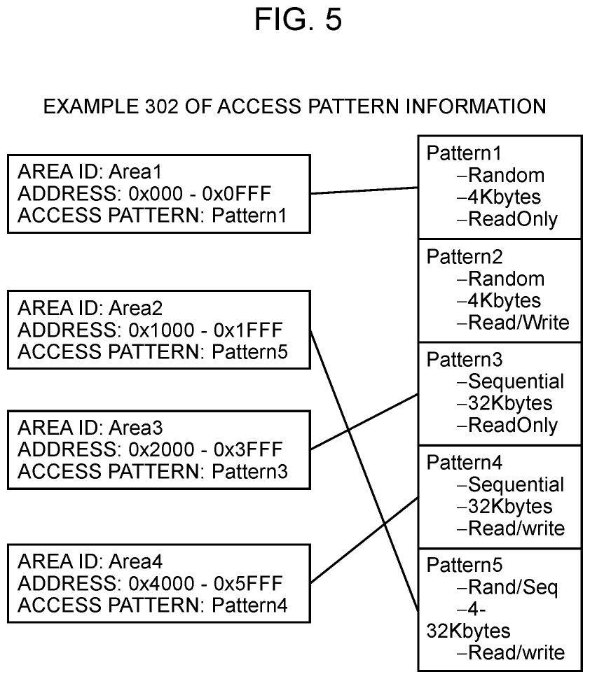

FIG. 5 illustrates example 302 of access pattern information managed by access pattern manager 7 and stored in access pattern storage 8.

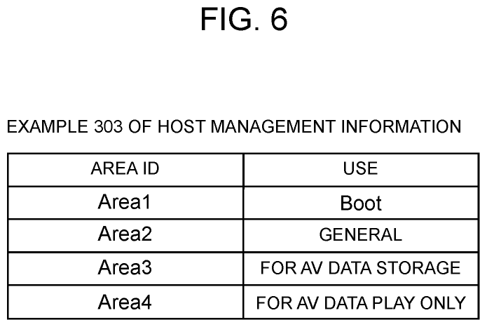

When setting of storage device 1 is completed, host device 2 stores and manages management information (example 303 of host management information) as illustrated in FIG. 6 and accesses storage device 1.

Although the means is not in question, it is necessary to write data in advance to a boot area that is read-only or AV data read-only area with respect to an area where setting of logical area management information and access pattern information have been completed. Accordingly, it goes without saying that it has a function of writing data by using a process other than the access pattern processing set in the initial state.

### 2.2.2 Operation of Virtual Storage

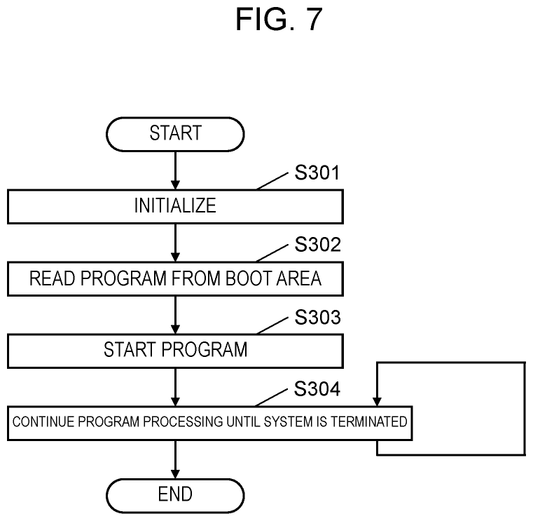

FIG. 7 is a flow illustrating an operation of host device 2 and storage device 1 for which setting of logical area management information and access pattern information have been completed.

When the virtual storage system is started, an initialization process of storage device 1 (step S301) is performed. In the initialization process, the logical-physical conversion table describing a relationship between a physical address of non-volatile memory 19 and a logical address to be accessed by host device 2 is created by logical-physical conversion table manager 9, and is stored in logical-physical conversion table storage 10. A method for creating the logical-physical conversion table will not be particularly mentioned. Host device 2 is started by reading software required for start, including the OS, from area “Area1” of storage device 1, at high speed by processing performed by random read-only processor 14 (step S302). When the system is started, host device 2 accesses storage device 1 as necessary (step S304), and repeats subsequent processing until the system is terminated.

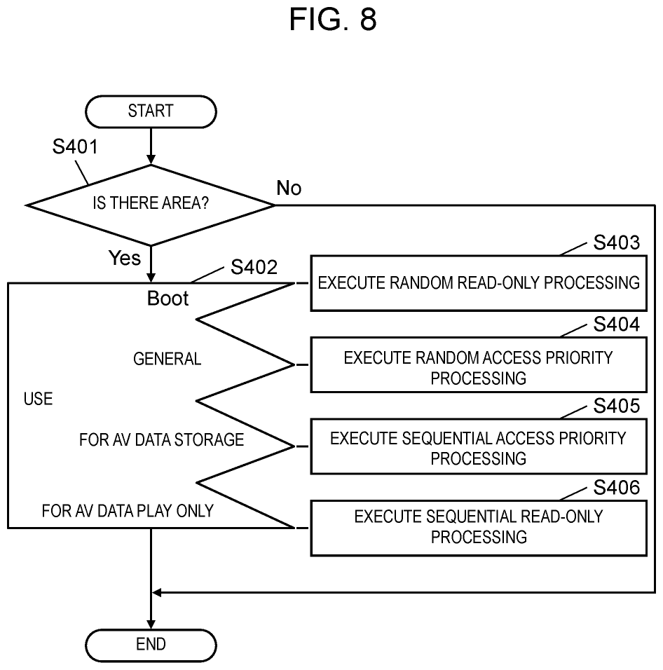

FIG. 8 illustrates a flow of processing that is repeated in a period from starting of host device 2 and starting of the program until finishing of the program.

First, storage device 1 checks whether or not a specified area has already been secured, and when it has not been secured, the process is ended (No in step S401). When the specified area has been secured (Yes in step S401), storage device 1 selects optimum pattern processing according to setting of an area to be accessed by a request from host device 2 (step S402), and meanwhile performs appropriate processing according to the access pattern (steps S403 to S406). Specifically, when any one of the plurality of divided logical areas is accessed from host device 2, access pattern processing manager 6 selects the access pattern corresponding to the accessed area from the access pattern information stored in access pattern storage 8. Then, access processing management and execution unit 5 performs processing on non-volatile memory 19 based on the access pattern specified by access pattern processing manager 6, and transfers data to host device 2 via storage interface 4.

Further, random access priority processor 13 can improve read and write efficiency of data by accessing the cache processor controlled by cache controller 11 as needed. A cache control method will not be particularly described, but is not limited to any special control method.

Random read-only processor 14 performs processing suitable for the access pattern used while normally reading a stored program, at once or partially, as in a boot area, for example.

Sequential access priority processor 15 performs processing suitable for writing and reading a large amount of continuous data such as AV data. For example, sequential access priority processor 15 can process a large amount of data at high speed by increasing the unit of accessing, or the like.

Sequential read-only processor 16 needs to read AV data already stored in storage device 1 in large volume and at stable speed, and thus performs processing suitable for play of AV data by, for example, contrivance such as increasing advance reading of data.

### 2.3. Effects and the Like

As described above, in the present exemplary embodiment, the storage device in the present disclosure operates while automatically selecting pattern processing according to the area and the use in response to the request of the host device, and thus it is possible to respond to host devices for various uses with one storage device.

### 3. Second Exemplary Embodiment

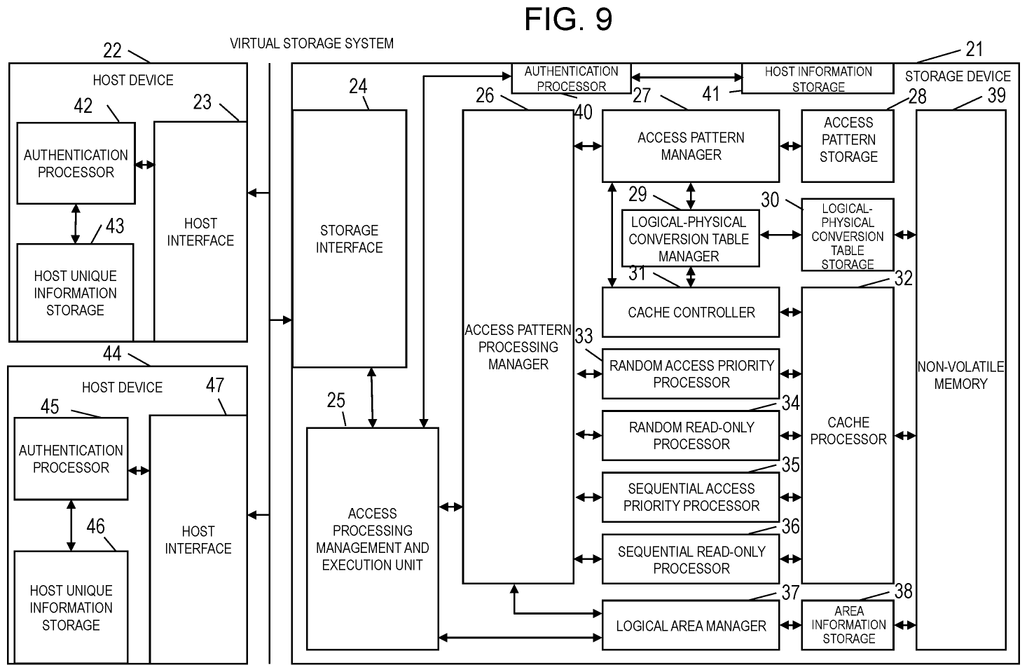

Hereinafter, a second exemplary embodiment will be described with reference to FIGS. 9 to 18.

### 3.1. Configuration of Virtual Storage System

FIG. 9 is a configuration diagram of a virtual storage system according to the second exemplary embodiment. The virtual storage system is constituted of host device 22, host device 44, and storage device 21.

Storage device 21 is connected to host device 22 having host interface 23 and to host device 44 having host interface 47 via storage interface 24.

Storage device 21 has logical-physical conversion table manager 29 that manages a logical-physical conversion table according to a physical address of non-volatile memory 39 and an access pattern according to a use specified by host device 22 and host device 44, logical-physical conversion table storage 30 that stores the logical-physical conversion table managed by logical-physical conversion table manager 29, logical area manager 37 that divides non-volatile memory 39 storing data into several logical areas in response to a request from host device 22 or host device 44 to manage non-volatile memory 39, area information storage 38 that stores information regarding the logical areas managed by logical area manager 37, random access priority processor 33 that preferentially processes random access according to an access pattern requested by host device 22 or host device 44, random read-only processor 34 that performs random but read-only processing, sequential access priority processor 35 that preferentially processes sequential access for accessing data such as image data and video data, sequential read-only processor 36 that performs sequential but read-only processing, access pattern manager 27 that manages an access pattern for the individual divided areas specified by host device 22 or host device 44, access pattern storage 28 that stores access pattern information managed by access pattern manager 27, cache controller 31 that manages cache processing based on the access pattern information, cache processor 32 that is cache-controlled, access pattern processing manager 26 that automatically selects optimum processing based on the access pattern information stored in access pattern storage 28 when there is access from host device 22 or host device 44, and access processing management and execution unit 25 that performs optimum processing based on an instruction from access pattern processing manager 26 and transfers data stored in non-volatile memory 39 to host device 22 or host device 44 via storage interface 24.

Storage device 21 performs the optimum processing when host device 22 or host device 44 accesses a divided area of non-volatile memory 39, and transfers read data from non-volatile memory 39 to host device 22 or host device 44.

Further, storage device 21 according to the second exemplary embodiment includes authentication processor 40 for authenticating with host device accessing non-volatile memory 39, and host information storage 41 for storing unique information required for authentication. Authentication processor 40 is an example of a storage-side authentication unit.

Further, storage device 21 according to the second exemplary embodiment can limit areas that can be accessed and access patterns that can be set by performing authentication with host device 22 or host device 44. Each of host devices 22, 44 has authentication processor 42, 45 for performing authentication with storage device 21 by using host unique information, which is unique information of the host device stored in host unique information storage 43, 46. Authentication processor 42, 45 is an example of a host-side authentication unit.

### 3.2. Operation of Virtual Storage System

Operations of the virtual storage system according to the second exemplary embodiment will be described focusing on operations different from that of the virtual storage system according to the first exemplary embodiment. This is because the virtual storage system according to the second exemplary embodiment has a configuration in which two host devices are connected to one storage device, but a basic function regarding operations between the individual host devices and the storage device is similar.

The basic function in the present disclosure is to logically divide one storage and select and execute a method of optimum access to the non-volatile memory storing data according to the uses of the individual divided areas.

Hereinafter, among operations of the virtual storage system according to the second exemplary embodiment, parts different from the operations of the virtual storage system according to the first exemplary embodiment will be mainly described with reference to the drawings.

### 3.2.1. Authentication Operation and Area Information Setting Operation

In the virtual storage system according to the second exemplary embodiment, for example, authentication processor 42 of host device 22 performs authentication with authentication processor 40 of storage device 21 by using the host unique information stored in host unique information storage 43, and only when the authentication is successful, the information used in the authentication process is stored in host information storage 41, and thereafter the host information is used for operation. An authentication process with host device 44 is also similar.

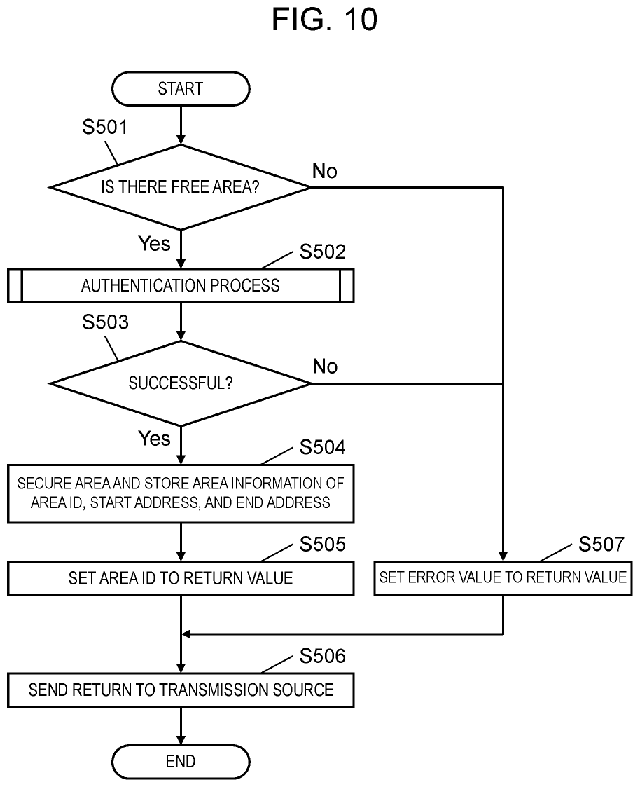

FIG. 10 illustrates a flow for setting area information in storage device 21 according to the second exemplary embodiment. A difference from storage device 1 according to the first exemplary embodiment is that an authentication process is performed between the host device and the storage device (step S502), and a process based on a result of the authentication is performed.

When the authentication process fails, an error value is set as a return value (step S507), the error value is returned to the host device (step S506), and the process ends. Only when the authentication process is successful, the area ID, start address, and end address information are stored in area information storage 38 (step S504), the area ID, for example, “Area1” is set as a return value (step S505) and returned to the host device (step S506), and the process ends.

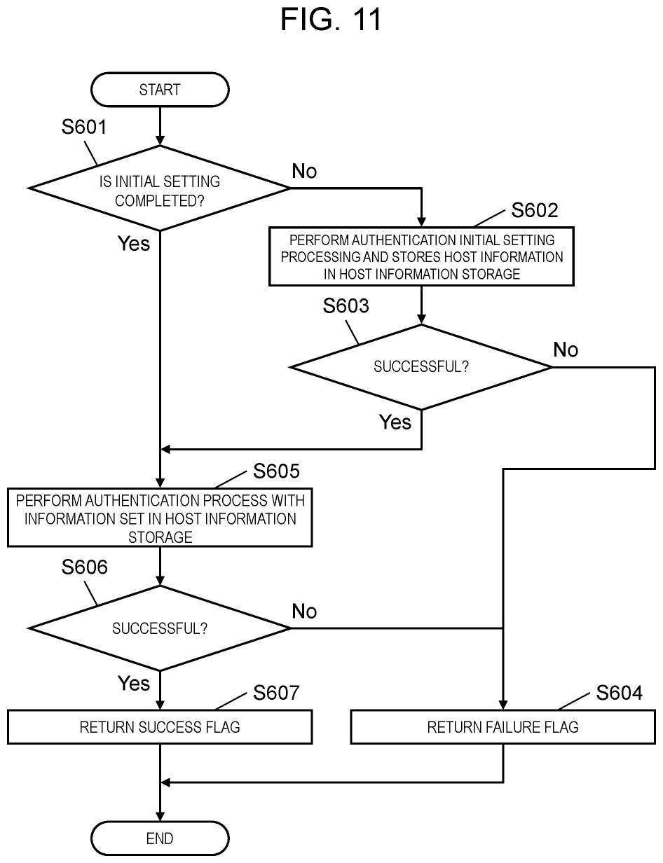

FIG. 11 illustrates a detailed flow of the authentication process. In the authentication process, first, it is checked whether or not the authentication process has been initialized (step S601), and when it has not been initialized, an authentication initial setting process is performed, and the host ID that is host unique information as well as certificate information used in public key infrastructure (PRI) authentication and host information of area ID information to which the authentication is applied are stored in host information storage 41 (step S602). When the authentication initial setting process fails (No in step S603), a failure flag is returned to the host device (step S604) and the process ends. When the initial authentication setting is successful (Yes in step S603), the authentication process with information set in the host information storage is performed (step S605). When the authentication process fails (No in step S606), a failure flag is returned to the host device (step S604) and the process ends. When the authentication process is successful (Yes in step S606), a success flag is returned to the host device (step S607) and the process ends.

### 3.2.2. Access Information Setting Operation

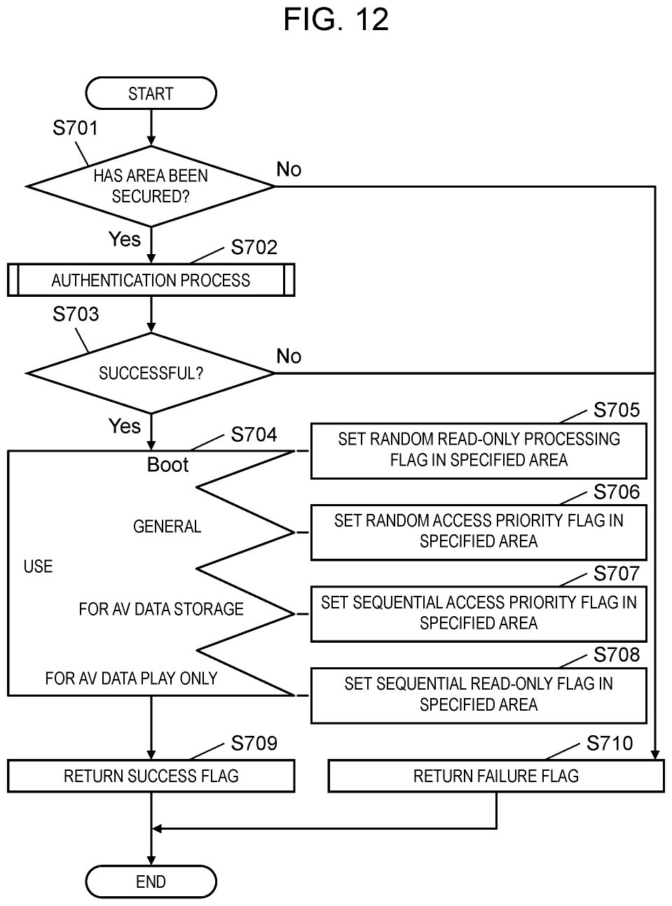

FIG. 12 illustrates a flow of setting access information from the host device in which the authentication process is successful. When the authentication with the host device is successful (Yes in step S703), depending on the use requested by the host device (step S704), for example, if the use is boot, a random read-only processing flag is set in an area specified for the host device (step S705), and a success flag is returned to the host device (step S709). When the authentication with the host device fails (No in step S703), a failure flag is returned to the host device (step S710). Other than the condition of whether or not the authentication process is successful (step S703), the operation is the same as that of the first exemplary embodiment (see FIG. 4), and thus the description thereof will be omitted.

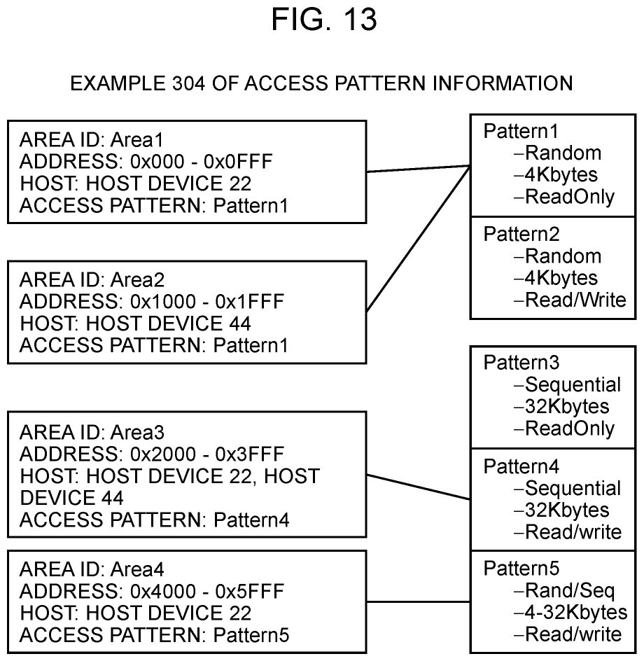

FIG. 13 illustrates example 304 of the access pattern information when host device 22 and host device 44 successfully authenticate with storage device 21 in the virtual storage system according to the second exemplary embodiment, and the area information and the access pattern are stored for each of them.

The access pattern information means that, for example, the area ID “Area1” has an address of 0x0000 to 0x0FFF, host device 22 has the right to access “Area1”, and the access pattern is “Pattern1”, and also means that the access pattern “Pattern1” is random read-only and has an access unit of 4 Kbytes.

Further, it is illustrated that both host device 22 and host device 44 can access the area ID “Area3”.

Further, it is illustrated that the access pattern of the area ID “Area4” is “Pattern5”, and the access unit can be from 4 Kbytes to 32 Kbytes. However, there are four types of 4 Kbytes, 8 Kbytes, 16 Kbytes, and 32 Kbytes that can be selected.

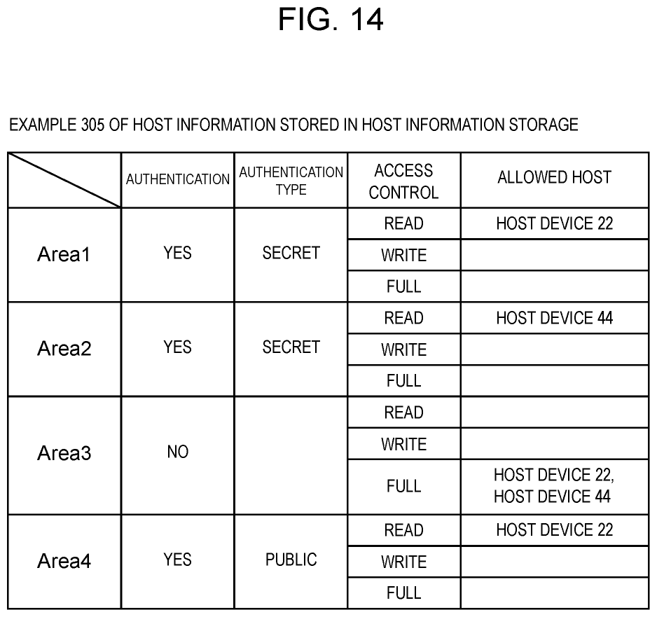

FIG. 14 illustrates an example of host information stored in host information storage 41 in storage device 21 according to the second exemplary embodiment. According to host information example 305, host device 22 can access “Area1”, “Area3”, “Area4”, and host device 44 can access “Area2” and “Area3”.

“Area1” and “Area2” indicate that authentication is required and both require authentication using a private key, and even when the authentication is successful, only reading is possible. On the other hand, “Area3” does not need authentication, and thus can be accessed from host device 22 and host device 44. For “Area4”, authentication by public key cryptography is required, which means only reading is possible for host device 22.

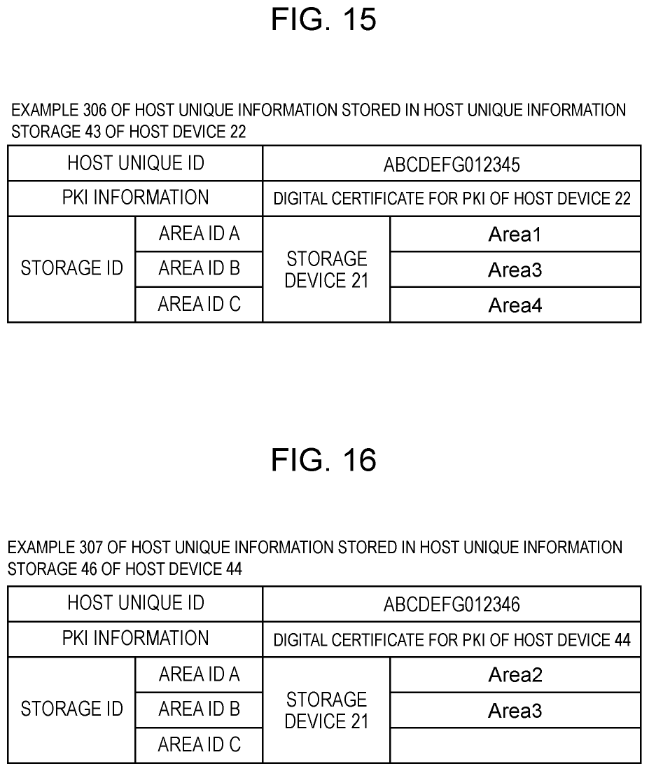

FIGS. 15 and 16 illustrate examples 306, 307 of host unique information stored in host unique information storages 43, 46 of host devices 22, 44, respectively, when the host information is illustrated in FIG. 14. Here, as the host unique information illustrated in FIG. 15, first, a host unique ID uniquely assigned to every host device, certificate information for PKI authentication, a connected storage ID, and an accessible area ID are described. In the second exemplary embodiment, the storage ID that identifies the storage device is described as storage device 21 for convenience. Note that, needless to say, the length of the host unique ID may be any length as long as it is a unique ID to each host device. Further, needless to say, a digital certificate for PKI may be a commonly used one.

### 3.2.3. Basic Operation of Virtual Storage System According to Second Exemplary Embodiment

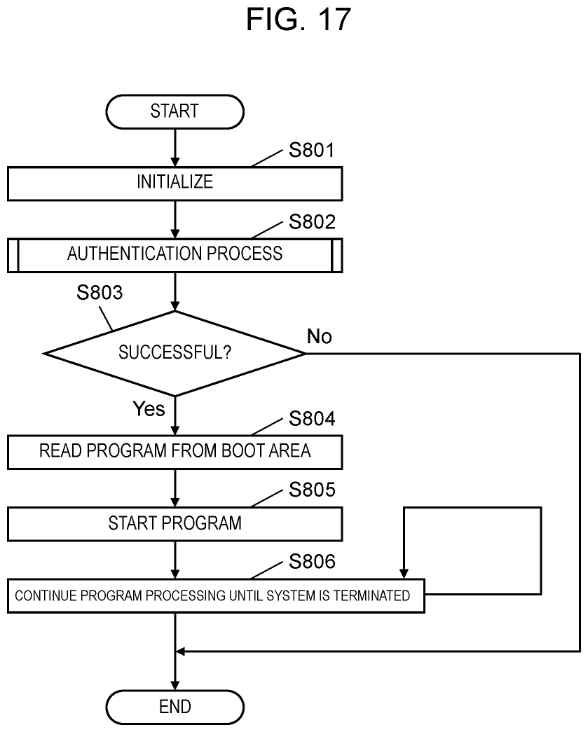

FIG. 17 illustrates a basic operation of the virtual storage system according to the second exemplary embodiment. A difference from the operation of the virtual storage system according to the first exemplary embodiment is that an authentication process (step S802) after initialization (step S801) and a success or failure checking process (step S803) thereof are included. The authentication process is performed when the host device and storage device are connected. Note that the flow of the authentication process performed in step S802 is the same as the authentication process flow illustrated in FIG. 11, and is omitted here.

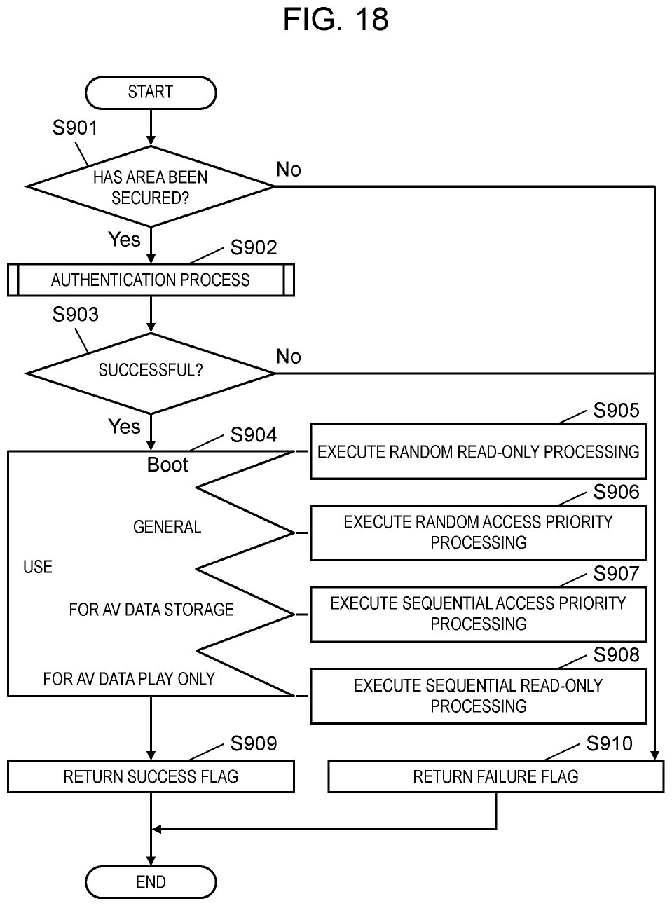

FIG. 18 illustrates a flow of pattern processing execution in the virtual storage system according to the second exemplary embodiment. A difference from the pattern processing execution flow in the virtual storage system according to the first exemplary embodiment is that the authentication process (step S902) is inserted before processing for each use (step S904). It is similar to the virtual storage system according to the first exemplary embodiment except that normal processing is performed only when the authentication is successful.

### 3.2.4. Logical-Physical Conversion Table Processing

Storage device 21 according to the second exemplary embodiment is also different from the operation of storage device 1 according to the first exemplary embodiment in that logical-physical conversion table manager 29 cooperates with access pattern manager 27 to perform different processing for every access pattern. Since storage device 21 according to the second exemplary embodiment is basically authenticated with the host device and the storage device, it is necessary to maintain security between the authenticated host device and storage device. Accordingly, for example, in an area where access is permitted only to an authenticated host device, the logical-physical conversion table is created so as not to share cells of non-volatile memory 39. Thus, a non-erased cell is prevented from being used in other areas.

### 3.2.5. Cache Processing

In storage device 21 according to the second exemplary embodiment, cache controller 31 also cooperates with access pattern manager 27 to access information stored in access pattern storage 28, thereby changing the cache control method for every access pattern. For example, for an area processed by sequential read-only processor 36, data read directly from non-volatile memory 39 is sent directly to the host device without using a cache to thereby eliminate unnecessary copying processing, and thus reading can be performed at high speed. Further, for an area processed by random access priority processor 33, a hit rate is increased and access performance is improved by using a high-speed cache algorithm.

### 3.3. Effects and the Like

As described above, in the present exemplary embodiment, the storage device in the present disclosure includes an authentication processor for authenticating with a host device that accesses a non-volatile memory, and a host information storage needed for authentication. The storage device uses information unique to the host device to perform authentication with the host device including an authentication processor that performs authentication with the storage device, and can thereby limit areas that can be accessed and access patterns that can be set.

### 4. Other Exemplary Embodiments

As described above, the first exemplary embodiment and the second exemplary embodiment have been described as examples of techniques disclosed in the present application. However, the techniques in the present disclosure are not limited to this, and can be applied to exemplary embodiments in which changes, replacements, additions, omissions, and so on are made as appropriate.

Further, the accompanying drawings and the detailed description are also provided to illustrate exemplary embodiments. Therefore, among the components described in the accompanying drawings and the detailed description, not only components necessary for solving the object but also components not necessary for solving the object can also be included in order to exemplify the above technology. Therefore, the fact that these unnecessary components are described in the accompanying drawings or detailed description should not immediately determine that those unnecessary components are necessary.

Further, since the above-described exemplary embodiments are for exemplifying the techniques in the present disclosure, various changes, replacements, additions, omissions, and the like can be made within the claims or the equivalent scope thereof.

### INDUSTRIAL APPLICABILITY

The present disclosure is applicable to a storage connected to one or more ECUs and CPUs. Specifically, the present disclosure is applicable to in-vehicle devices, game devices, and the like.

What is claimed is:

1. A storage device that is connected to a host device, the storage device comprising:
a non-volatile memory that stores data;
a logical area manager that divides the non-volatile memory into a plurality of logical areas to manage the plurality of logical areas;
an area information storage that stores information regarding the plurality of logical areas managed by the logical area manager;
an access pattern manager that manages access patterns that are designated by the host device and each correspond to a corresponding one of the plurality of logical areas that has been divided;
an access pattern storage that stores information regarding the access patterns managed by the access pattern manager;
an access pattern processing manager that selects, when any one of the plurality of logical areas is accessed from the host device, an access pattern corresponding to the any one of the plurality of logical areas accessed from the information regarding the access patterns stored in the access pattern storage; and
an access processing management and execution unit that performs processing on the non-volatile memory based on the access pattern selected by the access pattern processing manager and transfers data to the host device.

2. The storage device according to claim 1, wherein the non-volatile memory is divided into the plurality of logical areas according to a request of the host device.

3. The storage device according to claim 1, wherein at least one of the access patterns is either random, random read-only, sequential, and sequential read-only.

4. The storage device according to claim 1, further comprising:
a logical-physical conversion table manager that optimizes control for each of the access patterns by using the information regarding the access pattern;
a logical-physical conversion table storage that stores a logical-physical conversion table managed by the logical-physical conversion table manager;
a cache controller that optimizes control for each of the access patterns; and
a cache processor that performs cache processing.

5. The storage device according to claim 1, further comprising a storage-side authentication unit that authenticates the host device using unique information based on the host device, wherein
the host device includes a host-side authentication unit that authenticates the storage device using the unique information, and
the storage-side authentication unit enables access to any one of the plurality of logical areas that has been divided only when the storage-side authentication unit and the host-side authentication unit are mutually authenticated.

6. The storage device according to claim 1, wherein the host device is hardware of an electric controller unit (ECU) or a central processing unit (CPU).

7. The storage device according to claim 6, wherein an operating system (OS) or application operating on the hardware is authenticated as the host device.

8. The storage device according to claim 6, wherein a process or a thread operating on the hardware is authenticated as the host device.
